(19) United States
(12) Patent Application Publication
(10) Pub. No.: US 2005/0100820 A1
(43) Pub. Date: May 12, 2005

(54) Surface protective film

(76) Inventors: Masayuki Satake, Osaka (JP); Hideo Abe, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/969,236

(22) Filed: Oct. 21, 2004

(30) Foreign Application Priority Data
Oct. 24, 2003 (JP) 2003-364758

(51) Int. Cl. G03C 1/85

(52) U.S. Cl. 430/271.1; 399/147; 430/14

(57) ABSTRACT

Provided is a surface protective film capable of effectively suppressing formation of a scratch or a recess on an optical film and formation of an indentation on a pressure-sensitive adhesive layer while in transportation or storage even in a case where foreign matters intrudes into between layers of stacked optical films, which is “a roll product” or a punched product”. Furthermore, provided are an optical film to which the surface protective film is adhered and an image display. A surface protective film is of a structure in which a foreign matter absorbing layer is provided on one surface of a base film.

### FIELD OF THE INVENTION

The present invention relates to a surface protective film. A surface protective film of the present invention is employed in protection of surfaces of various kinds of optical films such as a polarizing plate, a retardation plate and the like. Moreover, a surface protective film of the present invention is employed in protection of each of various kinds of image displays such as a liquid crystal display, an organic EL display, PDP (Plasma Display Film) and the like by adhering the film to a display panel surface thereof.

### DESCRIPTION OF THE BACKGROUND ART

Common surface protective films are of a structure in which pressure-sensitive adhesive layers are provided on base films such as a polyethylene terephthalate film, a polyethylene film and the like. The surface protective films each are adhered onto a member to be protected with the pressure-sensitive adhesive layer interposed therebetween to thereby prevent a scratch, contamination or the like from occurring on the member to be protected. As optical members to be protected, exemplified are optical films such as a polarizing plate and a retardation plate.

One surface of an optical film is protected by a surface protective film in each step of a fabrication process. On the other hand, the other surface thereof is provided with a pressure-sensitive adhesive layer formed thereon made of, for example, an acrylic pressure-sensitive adhesive or the like. The pressure-sensitive adhesive layer is covered with a release liner (a separator). The optical film with a surface protective film fabricated in this way is stored in a state of a roll obtained by winding up the optical film, or in a state of single sheets, superimposed one on another, obtained by being cut into sheets so as to match a liquid crystal cell size. The steps are ordinarily conducted in a clean room, but it is still difficult to perfectly remove dust generated from an operator or an inspector, punching chips occurring in punching the film and fine foreign matters such as dust attaching to a product during transportation.

If fine foreign matters intrude into between layers of a roll or between superimposed film sheets, there arises indentations caused by the foreign matters on the film or sheet. Such an indentation formed on an optical film itself causes a defect of non-use in terms of wrong appearance. A pressure-sensitive adhesive layer is lower in elasticity and has a tendency to form an indentation thereon with more of ease, compared with an optical film. If the indentation is formed on a pressure-sensitive adhesive layer, air is confined in a recess when an optical film is adhered to a LCD panel with a pressure-sensitive adhesive layer interposed therebetween and the air imparts a possibility of display defect.

Disclosed as a measure to solve the problem is a pressure-sensitive adhesive sheet roll obtained by superimposing polarizing plates with pressure-sensitive sheets thereon or retardation plates with pressure-sensitive adhesive sheets thereon, of a structure in each of which a protective tape is adhered onto one surface of a polarizing plate or a retardation plate, while a pressure-sensitive layer and a release paper are stacked in this order on the other surface thereof, on a laminate paper high in cushioning property and then winding the sheets and the laminate paper around a core (see JP-A No. 5-273545). Further disclosed as the measure is a protective structure of film polarizing plates in which a protective sheet is provided on one of the upper surface and the lower surface of each film polarizing plate in stacked plural film polarizing plates, and a flexible sheet with an elasticity lower than the protective sheet is sandwiched between a protective sheet and a corresponding film polarizing plate (see JP-A No. 11-258424).

A measure using a laminate paper high in cushioning property as described in JP-A No. 5-273545 is effective for a case where “a roll product” is employed, whereas in a case of “a punched product” where an optical film is cut into sheets so as to match a liquid crystal cell size and then the sheets as cut are stored in a superimposed state, operability is poorer, which is not justified as a practical method. The technique described in JP-A No. 11-258424 is a technique being employed in a case where “punched products” are stacked, disabling the technique to be used for “a roll product”.

### SUMMARY OF THE INVENTION

It is an object of the present invention to provide a surface protective film capable of effectively suppressing formation of a scratch or a recess on an optical film and formation of an indentation on a pressure-sensitive adhesive layer while in transportation or storage even in a case where foreign matters intrudes into between layers of stacked optical films, which is “a roll product” or “a punched product”. It is another object of the present invention to provide an optical film to which the surface protective film is adhered and an image display.

The present inventors have conducted serious researches in order to solve the tasks with a finding that the objects can be achieved with a surface protective film shown below, which has lead to the present invention.

That is, the present invention relates to a surface protective film of a structure in which a foreign matter absorbing layer is provided on one surface of a base film. A pressure-sensitive adhesive layer is preferably provided on the other surface of the base film.

The present invention relates to a surface protective film of a structure in which foreign matter absorbing layers are provided on both surfaces of a base film. A pressure-sensitive adhesive layer is preferably provided on the foreign matter absorbing layer.

A foreign matter absorbing layer is a layer having a cushioning property and foreign matters intruding into between layers of the stacked optical films can be absorbed into the foreign matter absorbing layer by providing the surface protective film on an optical film. Therefore, even in a case where an impact or vibrations are imposed on stacked optical films in a state where foreign matters are present between layers of the stacked optical films, generation of scratches or recesses on an optical film can be effectively prevented. Moreover, since it is prevented that an indentation is formed on a pressure-sensitive adhesive layer provided on one surface of an optical film, an optical film can be adhered to a panel without confining air therebetween.

In a surface protective film of the present invention, an antistatic layer is preferably provided between the base film and the foreign matter absorbing layer. In mounting an optical film on a liquid crystal cell, generally, the optical film on which a surface protective film is provided is adhered to the liquid crystal cell and thereafter, the surface protective film is peeled off. In this operation, however, the liquid crystal easily suffers alignment defect due to electrostatic charge caused by peeling-off. By providing an antistatic layer on an optical film to impart the optical film an antistatic function, the liquid crystal is prevented from generating alignment defect due to charge caused by peeling-off of the surface protective film.

In the surface protective film, an alignment angle of the base film itself is preferably 15° or less. If the alignment angle exceeds 15°, the optical film and the surface protective film takes a cross Nicor state therebetween and a tendency arises that both enter an extinction state, leading to a possibility of disturbance in inspection of optical characteristic.

In the surface protective film, a retardation of the base film itself is preferably 50 nm or less.

The present invention relates to an optical film with the surface protective film adhered thereto.

Furthermore, the present invention relates to an image display with the surface protective film adhered thereto.

### BRIEF DESCRIPTION OF THE DRAWINGS

FIG. 1 is a sectional view of a surface protective film of the present invention.

FIG. 2 is a sectional view of another surface protective film of the present invention.

FIG. 3 is a sectional view of an optical film with a surface protective film of the present invention.

### DESCRIPTION OF THE PREFERRED EMBODIMENTS

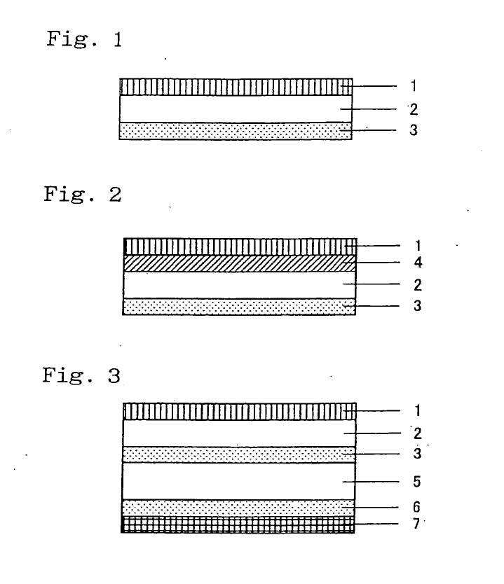

Description will be given of a surface protective film of the present invention below with reference the accompanying drawings. In FIG. 1, there is shown a sectional view of a surface protective film having a pressure-sensitive adhesive layer 3 on one surface of a base film 2, while having a foreign matter absorbing layer 1 on the other surface thereof. Foreign matter absorbing layers 1 are provided on both surfaces of a base film 2 and the pressure-sensitive adhesive layer 3 may be provided on a foreign matter absorbing layer 1 (not shown). In a case where the base film 2 and the foreign matter absorbing layer or layers 1 are films having pressure-sensitive adherence, the pressure sensitive adhesive layer 3 is not necessary. Note that a surface protective film of the present invention can be used in the shape of a sheet. In FIG. 2, there is shown a sectional view of a surface protective film in which an antistatic layer 4 is provided between a base film 2 and a foreign matter absorbing layer 1. In FIG. 3, there is shown a sectional view of an optical film 5 with a surface protective film adhered thereto and with a pressure-sensitive adhesive layer 6 and a separator 7 are provided thereon.

A surface protective film of the present invention is used in applications such as surface protection of optical films themselves having various kinds of optical functions such as that of a polarizing plate (film) and a retardation plate (film), respectively; and besides, such as surface protection exerted by the plates as constituent of various kinds of image displays such as a liquid crystal display and others.

As basic films 2, any of basic films that have been conventionally used in surface protect films can be used without a specific limitation. In general, as film materials, exemplified are transparent polymers from the viewpoints of inspectability and controllability by means of seeing-through such as polyester-based resin, a cellulose-based resin, acetate-based resin, polyether sulfone-based resin, polycarbonate-based resin, polyamide-based resin, polyimide-based resin, polyolefin-based resin and acrylic-based resin. A basic film can also be either alone or a laminate of one kind or two or more kinds of the above film materials and stretched products of the films can also be used.

A thickness of a base film 2 is generally 500 μm or less and preferably in the range of from 10 to 200 μm.

A retardation of a base film 2 is preferably 50 nm or less and more preferably 30 nm or less from the viewpoint of inspectability and controllability of an optical film by means of seeing-through. A film material revealing such a retardation is for example polycarbonate-based resin.

As pressure-sensitive adhesives constituting a pressure-sensitive adhesive layer 3, there can also be used acrylic-based, synthetic rubber-based, rubber-based, silicone-based pressure-sensitive adhesives and the like, and more preferable is an acrylic pressure-sensitive adhesive including an acrylic-based polymer as a base polymer from the viewpoints of a see-through property, weather resistance, heat resistance and the like. A weight-average molecular weight of an acrylic-based polymer (measured by means of GPC and obtained based on a calibration curve with standard polystyrene) is preferably on the order in the range of from 300,000 to 2,500,000.

As monomers used for acrylic-based polymers, there can be used various kinds of alkyl (meth)acrylates. Examples thereof that can be named are: (meth)acrylacid alkyl ester (alkyl esters having 1 to 20 carbon atoms such as methyl ester, ethyl ester, propyl ester, butyl ester, 2-ethylhexyl ester, isooctyl ester, isononyl ester, isodecyl ester, dodecyl ester, lauryl ester, tridecyl ester, pentadecyl ester, hexadecyl ester, heptadecyl ester, octadecyl ester, nonadecyl ester, eicosyl ester and the like), which can be used either alone or in combination.

In order to impart polarity to an acrylic-based polymer obtained from each of the monomers, there can be used, together with one of the (meth)acrylic acid alkyl esters, copolymerization monmers including: carboxylgroup containing monomers such as (meth)acrylic acid and itaconic acid and the like; hydroxyl group containing monomers such as hydroxylethyl (meth)acrylate, hydroxylpropyl(meth)acrylate and the like; amide group containing monomers such as N-methylolacrylamide; cyano group containing monomers such as (meth)acrylonitrile and the like; epoxy group containing monomers such as glicidyl (meth)acrylate and the like; vinyl esters such as vinylacetate and the like; and styrene-based monomers such as styrene, α-methylstyrene and the like.

Note that no specific limitation is placed on a polymerization method for an acrylic-based polymer and there can be adopted any of known polymerization methods such as solution polymerization, emulsion polymerization, suspension polymerization, UV polymerization and the like.

A pressure-sensitive adhesive describe above can contain a cross-linking agent. Examples of cross-linking agents include: a polyisocyanate compound, a polyamine compound, melamine resin, urea resin, epoxy resin and the like. Together with a pressure-sensitive adhesive described above, there can also be used a tackifier, a placticizer, a filler, an antioxidant, an ultraviolet absorbent, a silane coupling agent and the like.

No specific limitation is imposed on a forming method for a pressure-sensitive adhesive layer 3 and exemplified are a method in which a pressure-sensitive adhesive is coated on a release liner, the wet coat is dried and thereafter, the dried coat is transferred onto a base film 2 or a foreign matter absorbing layer 1 (a transfer method), a method in which a pressure-sensitive adhesive is coated directly onto a base film 2 or a foreign matter absorbing layer 1 and then the wet coat is dried (a direct application method) and the like method. A thickness (dry thickness) of a pressure-sensitive adhesive layer 3 is determined so as to achieve a necessary adhesion. The thickness is usually on the order in the range of from 1 to 100 μm and preferably on the order in the range of from 5 to 50 μm.

No specific limitation is placed on a structural material of a foreign matter absorbing layer 1 but preferable is a material lower in elasticity than a separator 7 provided on one surface of a base film 2 or an optical film 5. With such a material used in a foreign matter absorbing layer, the foreign matter absorbing layer is deformed and recessed to thereby absorb foreign matters in a case where the foreign matters are inserted between layers of stacked optical films each with a surface protective film thereon, thereby enabling deformation of a layer in contact with a foreign matter absorbing layer to be prevented effectively. In consideration of the viewpoints of inspectability and controllability of an optical film by means of seeing-through, as a structural material of a foreign matter absorbing layer, preferable is a rubber type material having rubber elasticity, substantially without a crystalline structure. Examples of rubber type materials include: nitrile rubber, acrylic rubber, ethylene propylene rubber, urethane rubber and the like.

No specific limitation is placed on a forming method for a foreign matter absorbing layer 1 and exemplified are: a method in which a raw composition is coated on a release liner and a reaction is caused in the wet coat, the coat is dried and thereafter, the dry coat is transferred onto a base film 2 or an antistatic layer 4 (a transfer method), a method in which a raw composition is coated directly on a base film 2 or an antistatic layer 4, a reaction is caused in the wet coat and then the wet coat is dried (a direct application method) and the like method.

No specific limitation is placed on a thickness of a foreign matter absorbing layer 1, but the thickness is preferably in the range of 0.5 to 50 μm and more preferably is in the range of from 1 to 5 μm. If the thickness is less than 0.5 μm, a tendency arises that generation of a damage or a recess in an optical film is hard to be suppressed because of impossibility to obtain a sufficient effect of absorbing a foreign matter. On the other hand, even if the thickness exceeds 50 μm, more of the effect of absorbing foreign matters is not realized and to the contrary, a tendency arises that disadvantage occurs in workability and cost. In order to facilitate unwinding of an optical film from a roll, a low adhesive resin such as silicone-based resin and fluorine containing resin may be mixed into a foreign matter absorbing layer in a proper amount. The low adhesive resin may be coated on the surface of a foreign matter absorbing layer.

An antistatic layer 4 can be formed by means of the following methods: a method in which an antistatic agent such as a surfactant, a conductive carbon, a metal powder or the like is mixed into a polymer such as polyester, which is usually adopted, to coat the mixture on a base film 2 and to form the coat, a method in which a surfactant or a conductive resin is coated on a base film 2 to dry the wet coat, a method in which a conductive material such as metal, a conductive metal oxide or the like is coated, evaporated or plated on a base film 2, and the like method.

As an antistatic agent, any of the antistatic agents may be used as far as a necessary antistatic effect can be ensured.

As surfactants, to be detailed, exemplified are anionic or ampholytic compounds such as a carboxylic acid-based compound, a sulfonic acid-based compound and a phophate-based salt; cationic compounds such as an amine-based compound and quaternary ammonium salt; nonionic compounds such as a fatty acid polyvalent alcohol ester-based compound and polyoxyethtylene adduct; and polymer compound such as a polyacrylic acid derivative.

As an antistatic agent, it is preferable that the agent contains a polymer having a pyrrolidium ring in its main chain. As a polymer having a pyrrolidium ring in its main chain, exemplified is “SHALLOL” manufactured by Dai-Ichi Kogyo Seiyaku Co., Ltd.

In order to improve adherence between a basic film and an antistatic layer, it is preferable to use an antistatic agent obtained by mixing a polyvinyl alcohol-based polymer as a binder into a cationic compound such as a quaternary ammonium salt. As such a base film, exemplified is “T100G” manufactured by Mitsubishi Polyester Film Corp. or the like.

As a conductive resin, exemplified are a polymer in which a conductive filler such as a tin-antimony-based filler, an indium oxide-based filler is dispersed.

As conductive materials for use in coating, evaporation or plating, exemplified are tin oxide, indium oxide, cadmium oxide, titanium oxide, metal indium, metal tin, gold, silver, platinum, palladium, copper, aluminum, nickel, chromium, titanium, iron, cobalt and copper iodide, and alloys and mixtures thereof. Note that the conductive materials may be used either alone or in combination of plural kinds. As kinds of evaporation and plating, exemplified are vacuum deposition, sputtering, ion plating, chemical deposition, spray thermal decomposition, chemical plating, electroplating and the like.

No specific limitation is imposed on a thickness of an antistatic layer 4 but the thickness is preferably on the order in the range of from 0.005 to 5 μm and especially preferably on the order in the range of from 0.01 to 1 μm.

As optical films to each of which a surface protective film of the present invention is adhered, there is employed optical films used in formation of a liquid crystal display or the like, on a kind of which no specific limitation is placed. As optical films, in addition to a polarizing plate, exemplified are an elliptically polarizing plate, a polarizing plate with an optical compensation function, a polarizing plate with a viewing angle widening function, a polarizing plate with a brightness enhancement function and the like. Each of the optical films are formed by stacking a retardation film, an optical compensation film, a brightness enhancement film or an antiglareness sheet on a polarizing plate.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials (iodine, dyes) is absorbed and aligned after stretched is suitably used. Although thickness of polarizer is not especially limited, the thickness of about 5 to 80 μm is commonly adopted.

A transparent protective layer can be provided on one surface or both surfaces of a polarizing plate described above for a purpose of water resistance or the like in the form of a coating layer using a polymer, a laminated layer of a film or the like. While a proper transparent material can be used as a transparent polymer or a transparent film material, which forms a transparent protective layer, preferably used is a transparent material excellent in transparency, mechanical strength, thermal stability, moisture barrier property and the like. While no specific limitation is placed on a thickness of a transparent protective layer, the thickness is generally on the order in the range of from 10 to 300 μm.

As materials of the above-mentioned transparent protective layer, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a transparent protective layer, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned.

A material forming a transparent protective layer contains (A) a thermoplastic resin having substituted and/or non-substituted imide groups on a side chain thereof and (B) a thermoplastic resin having substituted and/or non-substituted phenyl groups and nitrile groups on a side chain thereof. A protective film containing such thermoplastic resins (A) and (B) is described in, for example, WO 01/37007. Note that a protective film can also contain another resin even in a case where the thermoplastic resins (A) and (B) are main components.

As retardation films, exemplified are a birefringent film or a liquid crystal polymer film fabricated by monoaxially or biaxially stretching a polymer as a starting material, and the like. While no specific limitation is placed on the thickness of a retardation film, the thickness is generally on the order in the range of from 20 to 150 μm. A retardation film can be a laminate made of stretched films in two or more layers, having controlled optical characteristics such as a retardation, which can also be used as an elliptically polarizing plate obtained by stacking a polarizing plate for purposes of compensation of a retardation of a liquid crystal cell to thereby prevent coloration or widen a viewing angle range.

As high polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, polysulfones, polyethylene terephthalates, polyethylene naphthalates, polyethersulfones, polyphenylene sulfides, polyphenylene oxides, polyallyl sulfones, polyvinyl alcohols, polyamides, polyimides, polyolefins, polyvinyl chlorides, cellulose type polymers, or bipolymers, terpolymers, graft copolymers, blended materials of the above-mentioned polymers may be mentioned. These polymer raw materials make oriented materials (stretched film) using a stretching process and the like.

As liquid crystalline polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain skeleton, and polymers having mesogen parts comprising para-substituted ring compound units providing nematic orientation property as side chains via spacer parts comprising conjugated atomic groups may be mentioned. These liquid crystalline polymers, for example, is obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating.

A polarizing plate or a retardation film can also employed as a laminate to form a reflection polarizing plate, a semi-transparent layer type polarizing plate, a polarization separation polarizing plate or the like. An optical film exemplified above can also employed as an optical compensation film and various kinds of other viewing angle widening films, and as an optical film, exemplified is a brightness enhancement film and the like. A polarizing plate can be used as an antiglareness sheet by forming a reflection layer of a surface profile with fine depressions and protrusions combined on the surface thereof.

### EXAMPLES

While detailed description will be given of a surface protective film of the present invention based on examples, the present invention is not intended to be limited to the description of the example.

### Example 1

(Preparation of Acrylic-Based Pressure-Sensitive Adhesive)

According to a common method, copolymerization was conducted between 100 parts by wt of butyl acrylate and 6 parts by wt of acrylic acid in ethyl acetate to thereby obtain a solution at a solid matter concentration of 30 wt % of an acrylic-based copolymer of a weight-average molecular weight of 600,000 (in terms of polystyrene). Added to 100 parts by wt (as a solid matter) of the acrylic-based copolymer was 6 parts by wt of an epoxy-based cross-linking agent to obtain an acrylic pressure-sensitive adhesive composition.

(Preparation of Acrylic Rubber Composition)

A solvent-soluble acrylic rubber was dissolved in toluene to obtain an acrylic rubber composition at a solid matter concentration of 5%.

(Preparation of Surface Protective Film)

The acrylic pressure-sensitive adhesive composition was coated with an applicator on a non-antistatic surface of a polyester film (manufactured by Mitsubishi Polyester Film Corp. with a trade name of T-100G having a thickness of 38 μm and an alignment angle 10 degrees) with an antistatic layer on one surface thereof so that a thickness after drying is 25 μm and the wet coat was dried at 120° C. for 2 min to form a pressure-sensitive adhesive layer. Thereafter, the acrylic rubber composition was coated with the applicator on the antistatic layer so that a thickness after drying is 2 μm, the coat was dried at 120° C. for 2 min to form a foreign matter absorbing layer for preparation of a surface protective film.

(Preparation of Optical Film with Surface Protective Film)

A pressure-sensitive adhesive layer made of an acrylic pressure-sensitive adhesive was formed on one surface of a polarizing plate (obtained in a procedure in which a polyvinyl alcohol film was impregnated with iodine, the film was stretched, thereafter a triacetyl cellulose films were adhered to both sides of the stretched film with an adhesive) and a separator was stacked on the pressure-sensitive adhesive layer. Then, the surface protective film prepared above was adhered to the polarizing plate on the pressure-sensitive adhesive layer thereof to thereby prepare a polarizing plate with a surface protective film.

### Comparative Example 1

A surface protective film and an optical film with the surface protective film were prepared according to a method similar to that adopted in Example 1 with the exception that no foreign matter absorbing layer was provided.

The following evaluation test was conducted on each of the optical films with a surface protective film obtained in Example 1 and Comparative Example 1.

(Evaluation Method)

A prepared polarizing plate with a surface protective film was punched to obtain pieces of a 15-inch diagonal size and fifty pieces thereof were superimposed one on another. An weight of 5 kg was placed on the stacked plates and the stacked plates were left for 24 hours under the weight. The weight was removed from the stacked plates when the 24 hours elapsed and appearances of the individual plates were visually inspected, wherein evaluation was conducted on sets of 50 polarizing plates from Example 1 and Comparative Example 1, respectively, and counted were polarizing plates each having a scratch of 150 μm or more in length on a polarizing plate, or 3 or more indentations in a pressure-sensitive adhesive layer thereof as defective to obtain a fraction defective. The results are shown below.

(Evaluation Results)

Example 1: 0/50 (0%)
Comparative Example 1: 5/50 (10%)

As is understood from the results, scratches or indentations can be effectively prevented from occurring by using a surface protective film containing a foreign matter absorbing layer.

1. A surface protective film of a structure in which a foreign matter absorbing layer is provided on one surface of a base film.

2. The surface protective film according to claim 1, wherein a pressure-sensitive adhesive layer is provided on the other surface of the base film.

3. A surface protective film of a structure in which foreign matter absorbing layers are provided on both surfaces of a base film.

4. The surface protective film according to claim 3, wherein a pressure-sensitive adhesive layer is provided on the foreign matter absorbing layer.

5. The surface protective film according to claim 3, wherein an antistatic layer is provided between the base film and the foreign matter absorbing layer.

6. The surface protective film according to claim 3, wherein an alignment angle of the base film itself is 15° or less.

7. The surface protective film according to claim 3, wherein a retardation of the base film itself is 50 nm or less.

8. An optical film with the surface protective film, wherein the surface protective film according to claim 3 is adhered onto an optical film.

9. An image display with the surface protective film, wherein the surface protective film according to claim 3 is adhered onto an image display.

10. The surface protective film according to claim 1, wherein an antistatic layer is provided between the base film and the foreign matter absorbing layer.

11. The surface protective film according to claim 1, wherein an alignment angle of the base film itself is 15° or less.

12. The surface protective film according to claim 1, wherein a retardation of the base film itself is 50 nm or less.

13. An optical film with the surface protective film, wherein the surface protective film according to claim 1 is adhered onto an optical film.

14. An image display with the surface protective film, wherein the surface protective film according to claim 1 is adhered onto an image display.
